(19) United States
(12) Patent Application Publication
(10) Pub. No.: US 2007/0252021 A1
(43) Pub. Date: Nov. 1, 2007

(54) Shower Head

(76) Inventor: Alberto Cristina, Fontaneto D'Agogna (Novara) (IT)

Correspondence Address: SHOEMAKER AND MATTARE, LTD, 10 POST OFFICE ROAD - SUITE 110, SILVER SPRING, MD, 20910, US

(21) Appl. No.: 10/597,796

(22) PCT Filed: Mar. 31, 2006
(86) PCT No.: PCT/IT06/00207

§ 371 Date: Jun. 14, 2007

(51) Int. Cl. B05B 3/04

(52) U.S. Cl. 239/449

(57) ABSTRACT

A shower head comprising a pair of plates, for dispensing and closing, directly facing each other relative to an axial direction. A seal is directly arranged and pinched in compression between the plates so as to sealingly delimit with the plates a fluid collecting chamber. The shower head is especially thin, inexpensive to manufacture and to assemble.

### FIELD OF THE INVENTION

The present invention relates to a shower head.

### BACKGROUND OF THE INVENTION

Shower heads of the prior art comprise a dispensing plate inserted in a body connected to a hose for receiving inlet water.

However, such heads are cumbersome, expensive and complex to be made and assembled. Moreover, the heads of the prior art are often constructively restricted to circular shapes since usually, the dispensing plate is screwed inside the head body.

The problem of the present invention is to provide a shower head which solves the disadvantages mentioned with reference to the prior art.

### SUMMARY OF THE INVENTION

Such disadvantages are solved with a shower head in accordance with claim 1.

Other embodiments of the shower head according to the invention are described in the subsequent claims.

### BRIEF DESCRIPTION OF THE DRAWINGS

Further features and the advantages of the present invention will appear more clearly from the following description of preferred non-limiting embodiments thereof, wherein:

FIG. 1 shows a perspective view of a shower head according to an embodiment of the present invention;

FIG. 2 shows a perspective view of the shower head of FIG. 1, from a different angulation;

FIG. 3 shows an exploded view of the shower head of FIG. 1;

FIG. 4 shows a section view of the shower head of FIG. 1;

FIG. 5 shows a view of the enlarged detail V of FIG. 4;

FIG. 6 shows an exploded view of a shower head according to a further embodiment of the present invention;

FIG. 7 shows an exploded view of a shower head according to a further embodiment of the present invention;

FIG. 8 shows a section view of the shower head of FIG. 7;

FIG. 9 shows a view of the enlarged detail IX of FIG. 8.

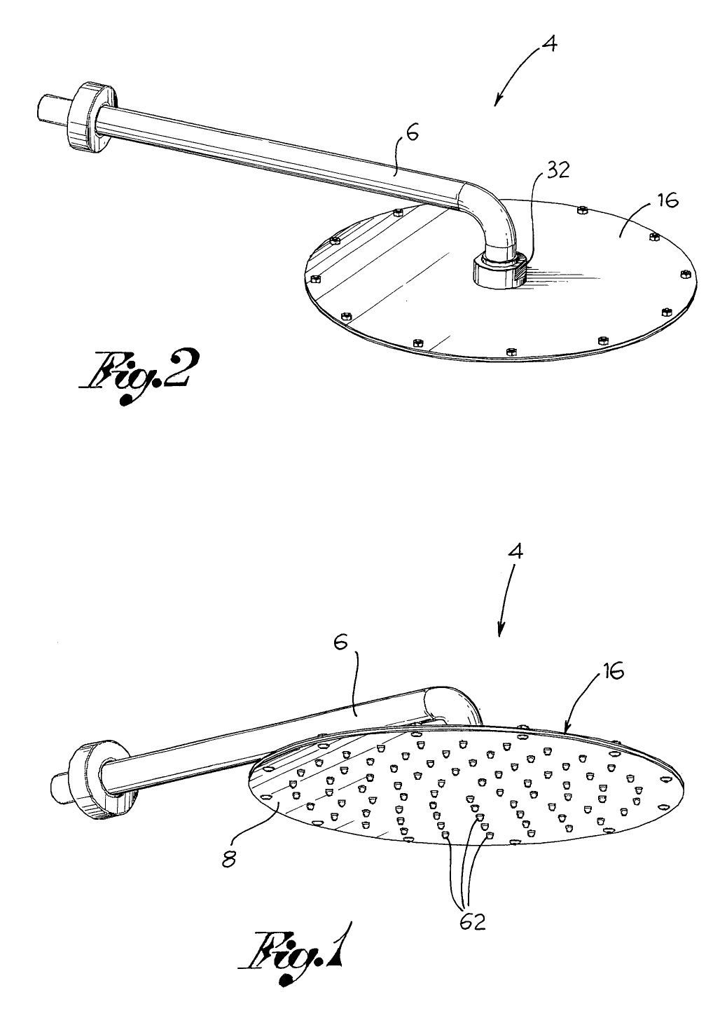

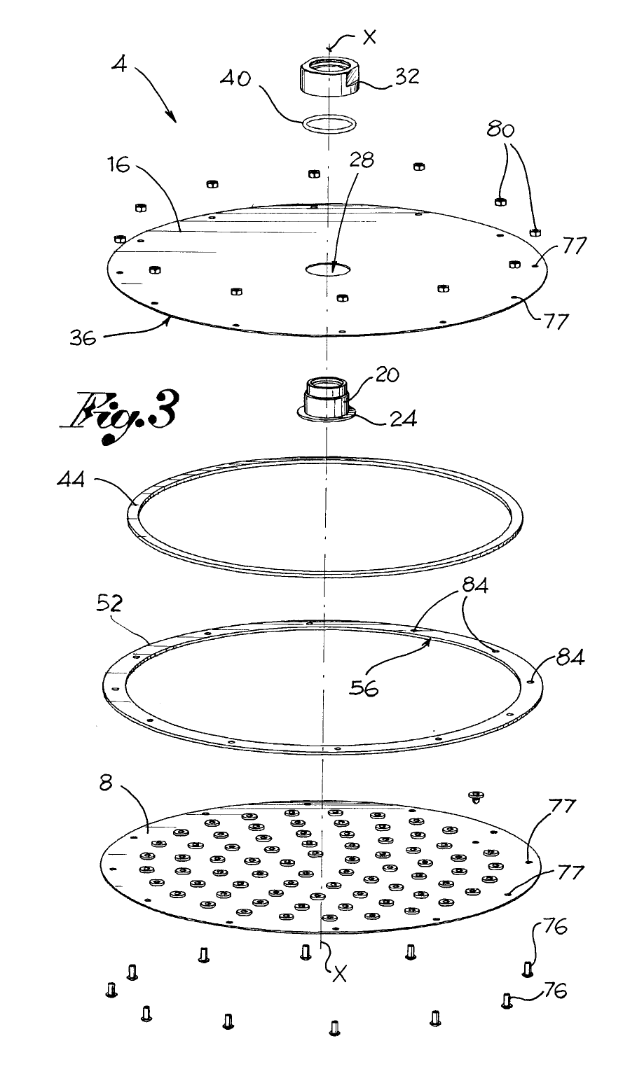

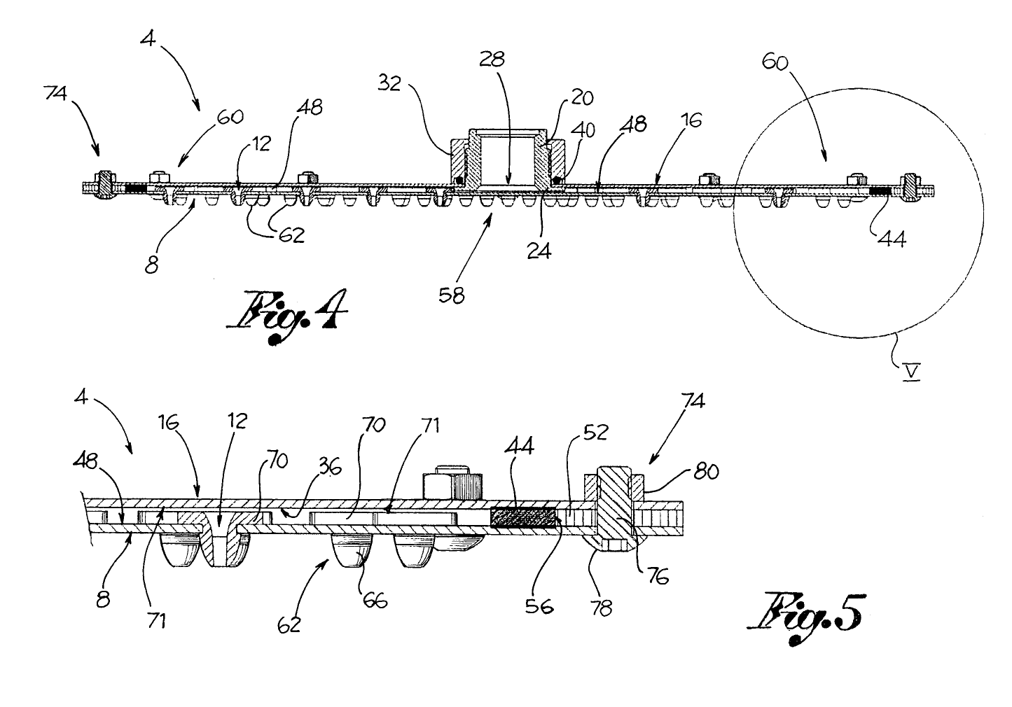

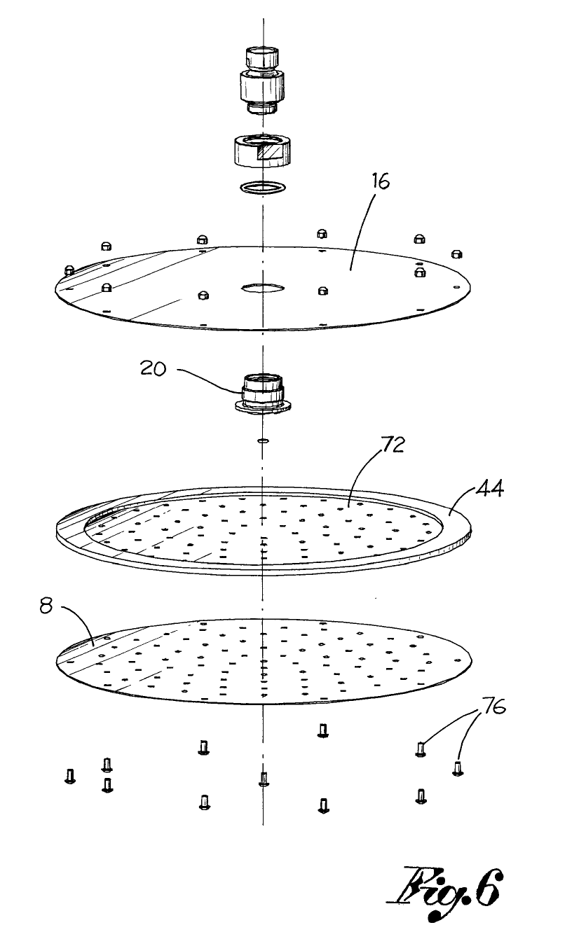

### DETAILED DESCRIPTION OF THE INVENTION

Elements or parts of elements in common between the embodiments described below are referred to with the same reference numerals.

With reference to the above figures, reference numeral 4 generically denotes a shower head, suitable for being connected to a water outlet, for example by a piping 6 or a hose.

According to an embodiment, shower head 4 comprises a dispensing plate 8 provided with at least one dispensing hole 12 for water dispensing. According to an embodiment, the dispensing plate 8 is circular and flat and comprises a plurality of dispensing holes 12 distributed on the surface of the plate itself. According to an embodiment, said dispensing holes 12 are evenly distributed on the dispensing plate 8. The plate shape is not limited to the circular shape but can be of any type, including asymmetrical shapes. The plates may even not be flat.

Shower head 4 further comprises a closing plate 16, in fluid connection with a water outlet, for example by a hollow cylindrical distributor 20, in communication with a water outlet. Distributor 20 is constrained to said closing plate 16 for example by a collar 24 having a diameter greater than an opening 28 of the same plate 16.

Preferably, a ring nut 32 is inserted on distributor 20 so as to influence collar 24 in abutment against an internal surface 36 of the closing plate 16. Ring nut 32 may be screwed on distributor 20 or it may be associated to distributor 20 in other ways, for example by gluing or welding. Preferably, an ‘O-ring’ 40 or any other means suitable for ensuring a fluid seal is arranged between distributor 20 and ring nut 32.

Advantageously, said plates 8, 16 are directly facing each other, relative to an axial direction X which, according to a possible embodiment, determines a symmetry axis for the same shower head 4. The geometry of plates 8, 16, in any case, is not restricted to axial-symmetric shapes.

Preferably, plates 8, 16 are counter-shaped to one another relative to said axial direction X; in other words, the projections of the profiles or edges of plates 8, 16 relative to the axial direction X overlap. Plates 8, 16, at faces directly facing one another, may be plane and parallel to each other and, according to further embodiments, they may be concave or convex.

Plates 8, 16 may for example be obtained by shearing or cutting from sheet; preferably, if plates 8, 16 are intended to be subject to surface treatments, it is possible to carry out such treatments on the sheets, before carrying out the subsequent cutting or shearing operations. In other words, in order to limit the manufacturing costs, it is possible to treat the sheet in advance with automatic finishing machines, thus minimising the costs due to the unit component treatment.

Advantageously, shower head 4 comprises a seal 44 directly arranged and pinched in compression between said dispensing 8 and closing 16 plates, so as to sealingly delimit with plates 8, 16 a collecting chamber 48 for dispensing the fluid through holes 12 of the dispensing plate 8.

Preferably, shower head 4 comprises a closing ring 52 arranged between said dispensing and distribution plates 8, 16. Preferably, ring 52 is arranged coaxially to seal 44 and has an axial thickness smaller than the axial thickness of seal 44 when at rest.

By axial thickness of seal 44 when at rest it is intended the thickness of seal 44 before the assembly configuration, that is, before the same is subject to compression between the two dispensing and distribution plates 8, 16.

Preferably, the closing ring 52 is substantially counter-shaped relative to seal 44; in other words, the closing ring 52 radially contains the seals and has the same profile as seal 44. According to an embodiment, in a deformed configuration, following the axial compression exerted by plates 8, 16, seal 44 radially expands, arranging in contact with an internal wall 56 of the closing ring 52, which faces towards the collecting chamber 48; in other words, according to an embodiment, the closing ring 52 radially influences seal 44 and cooperates therewith to the fluid seal of the shower head.

Seal 44 may have, in a rest configuration, a circular section, or for example quadrangular or any other shape; preferably, seal 44 is made of an elastic material, such as a silicone rubber, or another material suitable for ensuring a fluid seal, so as to elastically deform in compression under the closing action of plates 8, 16.

Preferably, in an assembly configuration, plates 8, 16 determine a collecting chamber 48 having a decreasing axial thickness between a central portion 58 and a peripheral portion 60 of shower head 4, relative to the axial direction X. At the central portion 58, distributor 20 also carries out the function of spacer in order to create an axial thickness of the collecting chamber 48 which should be larger on the central portion 58 and decreasing towards the peripheral portion 60.

Preferably, the closing ring 52 is substantially stiff at least in an axial direction so as to form an end of stroke in the approach between the plates during the shower head assembly step. The closing ring also ensures a minimum thickness of the collecting chamber so as to always ensure a water flow towards the dispensing holes 12.

According to an embodiment, shower head 4 comprises nozzles 62 suitable for being partly inserted in holes 12 of the dispensing plate 8.

Nozzles 62 comprise a dispensing portion 66 projecting from the dispensing plate 8 and a stopping portion 70 suitable for forming a stop in the introduction of nozzles 62 into the relevant holes 12.

Preferably, the axial thickness of said stopping portion 70 is smaller than the thickness of said closing ring 52, so that following the axial closing of the dispensing and distribution plates 8, 16, an air space 71 is formed between the stopping portion 70 and the closing portion 16, air space 71 being suitable for allowing the water flow through nozzles 62.

Nozzles 62 are for example made of rubber or any other material suitable for being elastically deformed for breaking scale deposits, so as to favour the operation for cleaning the nozzles, as well as the removal of any scale built thereon.

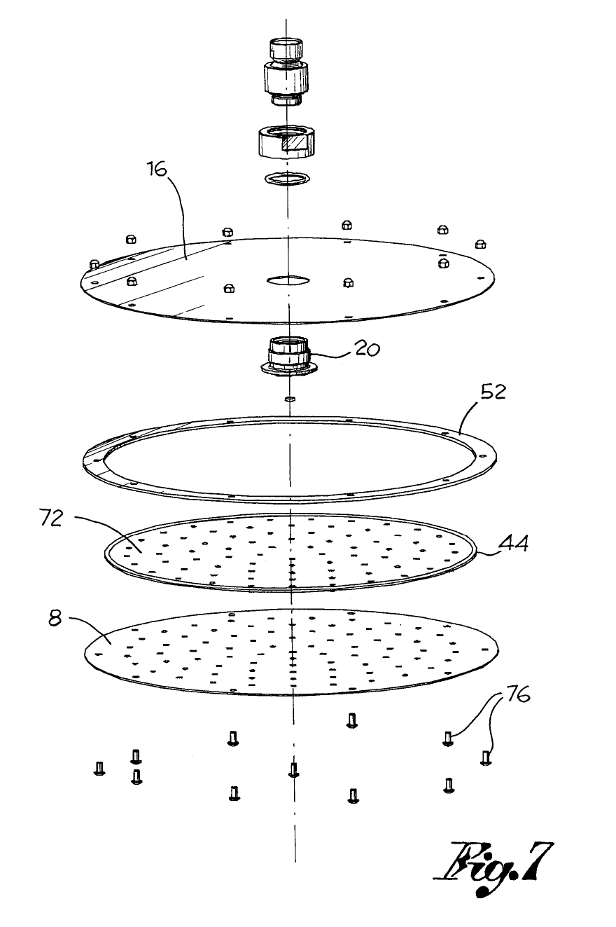

According to an embodiment (FIGS. 6, 7), seal 44 is made integral with a membrane 72 provided with said nozzles 62. In other words, shower head 4 comprises a membrane 72, preferably made of rubber, which integrally comprises an annular seal 44 suitable for being sealingly pinched between plates 8, 16 and a plurality of nozzles 62.

The thickness of membrane 72 is preferably smaller than the axial thickness of the annular seal 44 integral with membrane 72, so that in the operation for closing plates 8, 16, seal 44 is subject to compression by the same.

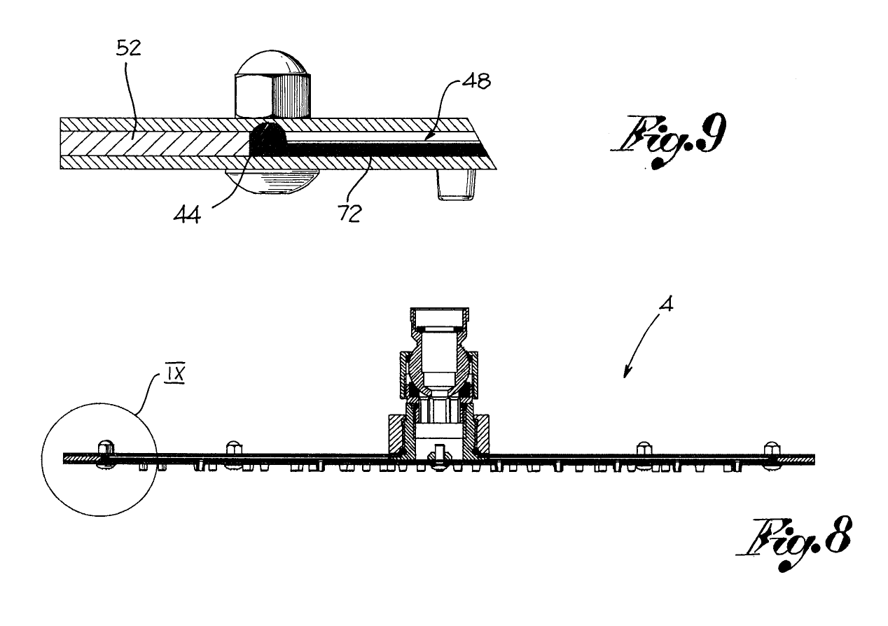

According to a further embodiment (FIGS. 7-9), seal 44 is made integral with membrane 72 provided with nozzles 62 and, coaxially to seal 44, a closing ring 52 is mounted. Preferably, the thickness of membrane 72 is smaller than the axial thickness of the closing ring 52 and of seal 44, so that in the operation for closing plates 8, 16, seal 44 is subject to compression by the same.

The dispensing 8 and distribution 16 plates may be axially constrained to each other in compression, for example by screw connecting means 74 or by any other means suitable for constraining the two plates 8, 16 into position so as to keep seal 44 in an axial compression status.

The screw connecting means 74 for example comprise a screw 76 passing through connecting holes 77 obtained on plates 8, 16, preferably at the peripheral portion 60 of the same.

Screw 76 comprises an opposite head 78 in abutment on one of said plates 8, 16, and having such length as to cross the plates and protrude on the opposite side so as to be constrained, on the other plate 16, 8, by a nut 80.

Preferably, the screw connecting means 74 are arranged on a portion of said plates radially external relative to said collecting chamber 48; in other words, the screw connecting means 74 do not axially cross the collecting chamber 48.

According to a preferred embodiment, the screw connecting means 74 are inserted through fixing holes 84 obtained on a peripheral portion of the closing ring 52, so as to lock said ring 52 into position relative to plates 8, 16.

As we can appreciate from the description, the shower head of the present invention allows overcoming the disadvantages exhibited by the shower heads of the prior art.

In particular, the shower head according to the invention exhibits assembly easiness and inexpensiveness.

As seen, the plates may be simply obtained by shearing from sheet or also for example by laser cutting. It is therefore possible to manufacture plates having any shape, even asymmetric.

In other words, unlike the shower heads of the prior art, which are restricted to few configurations of simple shape, the shower head according to the present invention allows creating complex shapes, using a production technology that requires no investments in expensive equipment like moulds, specific tools or else. Complex shapes can be manufactured in small batches at low cost. With the same shearing or cutting operations it is at the same time possible to make counter-shaped seals relative to the plates.

Moreover, it is possible to carry out the optional sheet polishing before the subsequent shearing or cutting so as to avoid carrying out the subsequent surface finishing processes on the single plates. In other words, it is possible to treat the sheet in advance with automatic finishing machines, thus minimising the costs due to the unit component treatment.

Moreover, the shower head exhibits very small overall dimensions. For example, it is possible to manufacture a shower head having an axial thickness, intended as overall thickness or distance between the plates, equal to about 4 mm.

The shower heads of the prior art do not allow achieving such small thicknesses.

The water flow between the plates, that is, the axial thickness of the collecting chamber, may advantageously range from a value of about 3.5 mm, for example at a central portion of the shower head, to a value of about 2 mm, at the radial periphery of the shower head. In this way, the even water distribution through all the holes of the distribution plate is favoured; in particular, it is possible to reduce the axial thickness of the collecting chamber moving from the central portion to the peripheral portion, so as to ensure a pressure evenness also on the outermost dispensing holes.

Moreover, the shower heads according to the present invention may be made in any shape. In fact, the cut or sheared sheets may even have asymmetrical shapes since the plates are not associated to one another by screwing.

A man skilled in the art may make several changes and adjustments to the shower heads described above in order to meet specific and incidental needs, all falling within the scope of protection defined in the following claims.

1. A shower head comprising
a dispensing plate provided with at least one hole for dispensing water,
a closing plate, in fluid connection with a water outlet, wherein said plates directly face each other relative to an axial direction and the shower head comprises a seal directly arranged and pinched in compression between said dispensing and closing plates, so as to sealingly delimit with the plates a collecting chamber in order to dispense the fluid through the holes of the dispensing plate.

2. A shower head according to claim 1, wherein the shower head comprises a closing ring arranged between said dispensing and distribution plates, the closing ring being arranged coaxially with said seal, and having an axial thickness smaller than the axial thickness of the seal when at rest.

3. A shower head according to claim 2, wherein said closing ring is shaped, complementary relative to the seal so that in a deformed configuration, following the axial compression exerted by the plates, the seal expands radially arranging in contact with an internal wall of the closing ring, which faces towards the collecting chamber.

4. A shower head according to claim 1, wherein said dispensing and distribution plates, in an assembled configuration, define a collecting chamber having a decreasing axial thickness between a central portion and a peripheral portion relative to a radial direction.

5. A shower head according to claim 4, wherein the closing ring is substantially stiff in the axial direction so as to form an end of stroke as the plates approach one another during the assembly step of the shower head and so as to ensure a minimum thickness of the collecting chamber for the water flow towards the dispensing holes.

6. A shower head according to claim 1, comprising nozzles suitable for being partly inserted in the holes of the dispensing plate.

7. A shower head according to claim 6, wherein said nozzles comprise a dispensing portion projecting from the dispensing plate and a stopping portion suitable for forming a stop during introduction of the nozzles into the relevant holes.

8. A shower head according to claim 7, wherein an axial thickness of said stopping portion is smaller than the thickness of said closing ring.

9. A shower head according to claim 1, wherein said seal is made integral with a membrane provided with said nozzles.

10. A shower head according to claim 9, wherein the axial thickness of the membrane is smaller than the axial thickness of the seal integral with membrane, so that in the operation for closing plates, seal is subject to compression by the same.

11. A shower head according to claim 9 further comprising a closing ring mounted coaxially to the seal, a closing ring is mounted.

12. A shower head according to claim 11, wherein the axial thickness of the membrane is smaller than the axial thickness of the closing ring and of the seal, so that in the operation for closing the plates, the seal is subject to compression by the plates.

13. A shower head according to claim 1, wherein said seal is made of a silicone rubber.

14. A shower head according to claim 1, wherein said dispensing and distribution plates are axially held together in compression by screw connecting means.

15. A shower head according to claim 14, wherein said screw connecting means comprise a screw passing through connecting holes obtained on the plates, and provided with a head abutting one of said plates, said screw being locked on an end opposite the head, on the side of the other plate by a nut.

16. A shower head according to claim 14, wherein said screw connecting means are arranged on a peripheral portion of said plates radially external to the collecting chamber.

17. A shower head according to claim 14, wherein said screw connecting means pass through fixing holes of said closing ring so as to lock said closing ring into position relative to the plates.

18. A shower head according to claim 1, wherein said dispensing and distribution plates, at faces directly facing each another, are substantially planar.

19. A shower head according to claim 1, wherein said dispensing and distribution plates, at faces directly facing each another, are concave or convex.
